(19) United States
(12) Patent Application Publication
(10) Pub. No.: US 2016/0026422 A1
(43) Pub. Date: Jan. 28, 2016

(54) SYSTEMS AND METHODS FOR PROVIDING ACCESSORY DISPLAYS FOR ELECTRONIC DEVICES

(71) Applicant: Case Labs LLC, Boulder, CO (US)

(72) Inventors: Andrew Brandt, Boulder, CO (US); Neil Blank, Eldorado Springs, CO (US); Perry Towle, Boulder, CO (US); Jan Delany, Longmont, CO (US); Chris Jacobs, Boulder, CO (US); Abby Jacobs, Boulder, CO (US); Mathew Gerson, Topanga, CA (US)

(21) Appl. No.: 14/876,450

(22) Filed: Oct. 6, 2015

Related U.S. Application Data
(63) Continuation of application No. 13/617,895, filed on Sep. 14, 2012.

(51) Int. Cl. G06F 3/14; H04W 4/02; G06T 1/00; H04M 1/725; G06F 3/0488; G06F 3/041

(52) U.S. Cl. CPC G06F 3/14; G06F 3/0488; G06F 3/041; G06T 1/0007; H04M 1/72519; H04W 4/02

(57) ABSTRACT

Systems and methods herein provide for an accessorizeable display of features for a processing device, such as a smart phone, a tablet computer, a laptop computer, or other processing devices. The display may be configured as a case on the “backside” or cover of the processing device that interfaces through a communication port of the processing device. In one embodiment, a system includes a display data module operable on the processing device to provide a graphical user interface via a first display device to a user of the processing device, and to interface with a second display device coupled to the processing device to display an image on the second display device. The system also includes a remote data center operable to retrieve the image and to communicate with the display data module through a network to provide the image to the second display device via the display data module.

### FIELD OF THE INVENTION

The invention relates to the field of electronics and, more specifically, to providing customizable “skins” to processing devices via electronic paper and other display device technologies.

### BACKGROUND

A variety of ways exist to allow a person to customize the appearance of certain devices, such as smart phones, laptop computers, etc. For example, many people encase their smart phones in decorative covers, or “skins”, to personalize their cell phones. However, these decorative covers are only capable of displaying a singular image because the skins are usually molded with a fixed design. While many designs may exist, each time a person wishes to change the design, it usually means that the person must purchase a new skin. Thus, there is no readily available means for quickly and selectively customizing a device.

### SUMMARY

Systems and methods herein provide for an alternate “accessorizeable” or customizable display of features for a processing device, such as a smart phone, a tablet computer, a laptop computer, or other processing devices. In one embodiment, the accessory display is operable to provide images that are somewhat static and, as a general result, the display only consumes power when the image is presented to the display, unlike typical backlit LCDs. The display may be configured as a case is on the “backside” or cover of the processing device that interfaces through a communication port of the processing device. Examples of such displays include electronic paper (also known as epaper or electronic ink) and low-power LCDs.

In one embodiment, a system includes a display data module operable on a processing device to provide a graphical user interface via a first display device (a display of the processing device) to a user of the processing device, and to interface with a second display device (an accessory display) coupled to the processing device to display an image on the second display device. The system also includes a remote data center operable to retrieve the image and to communicate with the display data module through a network to provide the image to the second display device via the display data module.

The remote data center may be further operable to interface with a plurality of data sources (e.g., subscription services, social media services, etc.) to provide a marketplace of data, to communicate the data marketplace to the display data module for display via the graphical user interface to the user, to receive a request for data from the data marketplace via the display data module, to retrieve the data from one or more of the data sources of the data marketplace based on the request, to generate the image from the data, and to transfer the image to the display data module for display via the second display device.

The display data module may also be also operable to interface with a camera of the processing device to retrieve another image, and to transfer the other image to the second display device for display. The display data module may also be operable to receive an input from the user of the processing device to configure the display data module. The configuration directs the remote data center to automatically retrieve the image, directs the display data module to receive the image from the remote data center, and directs the display data module to automatically display the image to the second display device. The display data module may also be operable to process the image to provide the image to the user interface, and to receive input through the user interface to edit the image. The display data module may also be operable to retrieve information (e.g., calendar, email, text message, etc.) from the processing device to generate another image for display via the second display device.

The various embodiments disclosed herein may be implemented in a variety of ways as a matter of design choice. For example, the embodiments may take the form of physical machines, computer hardware, software, firmware, or combinations thereof. In another embodiment, a computer readable medium is operable to store software instructions for displaying images to the accessory display. These software instructions are configured so as to direct a processor or some other processing system to operate in the manner described above. Other exemplary embodiments may be described below.

### BRIEF DESCRIPTION OF THE DRAWINGS

Some embodiments of the present invention are now described, by way of example only, and with reference to the accompanying drawings. The same reference number represents the same element or the same type of element on all drawings.

FIG. 1 is a block diagram of an exemplary system for providing content to a display device associated with a processing device.

FIG. 2 is a flow chart of an exemplary process of the system of FIG. 1.

FIGS. 3A-3D are exemplary views of a smart phone implementing the system of FIG. 1.

FIG. 4 is block diagram of the system of FIG. 1 interacting with a plurality of data sources.

FIGS. 5-8 are block diagrams of an exemplary user interface for implementing the system of FIG. 1 on a smart phone.

FIG. 9 is another exemplary flowchart of the system of FIG. 1.

FIG. 10 is another block diagram of the exemplary system of FIG. 1 operable with a camera module.

FIGS. 11A and 11B illustrate image optimization for a processing device.

FIGS. 12 and 13 are block diagrams illustrating Internet trending functionality that may be implemented with the system of FIG. 1.

FIG. 14 is a block diagram of an exemplary processing system operable to implement system of FIG. 1.

FIG. 15 is a perspective view of a case employing the system of FIG. 1 in an actual reduction to practice.

### DETAILED DESCRIPTION OF THE DRAWINGS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below.

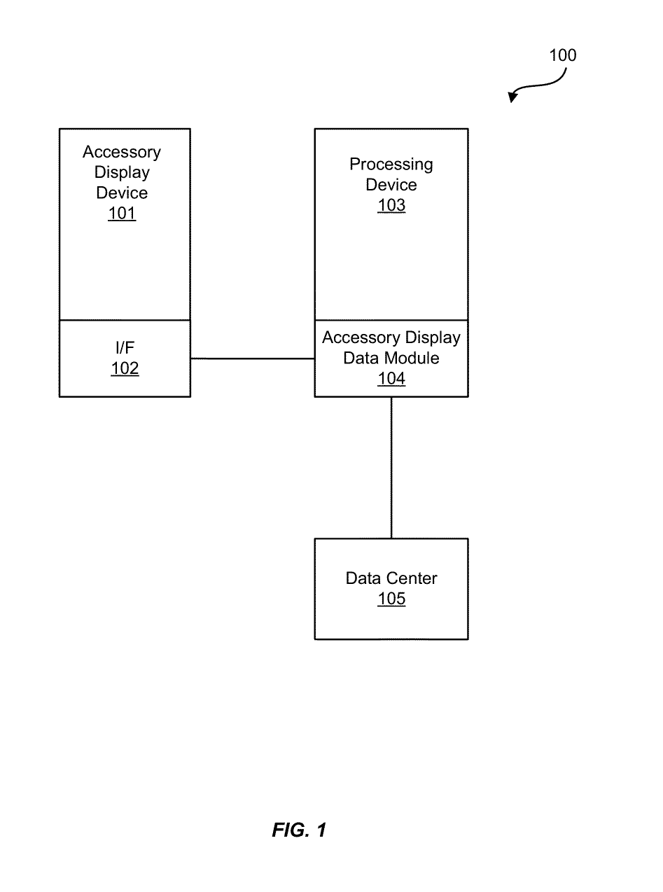

FIG. 1 is a block diagram of an exemplary system 100 for providing content to an accessory display device 101 associated with a processing device 103. The display device 101 is any type of device operable to display image data without the power consumption of traditional backlit LCDs. Such displays are generally used to provide static images that may be occasionally refreshed. Examples of such displays include electronic paper displays and low-power LCDs. Electronic paper relates to any display technology which is designed to mimic the appearance of ordinary ink on paper. Unlike conventional backlit flat panel displays which emit light, electronic paper devices reflect light like ordinary paper. This display technology can hold static text and images almost indefinitely without using electricity, while allowing images to be changed later. An electronic paper device may be implemented as an electrophoretic display, an electro-wetting display, and/or an electrofluidic display as a matter of design choice. Flexible electronic paper displays have also been implemented using plastic substrates and plastic electronics for the display backplane.

The display device 101 includes an interface 102 operable to communicate with and receive data from the processing device 103. The processing device 103 is any system comprising electronics and software operable to provide image data to the display device 101. For example, the processing device 103 may be a smart phone, a desktop computer, a tablet computer, a laptop computer, or the like. In this embodiment, a display data module 104 is operable with the processing device 103 to transfer image data to the interface 102 of the display device 101 such that the display device 101 may display the image data.

The system 100 also includes a remote data center 105 operable to transfer image data to the display data module 104 such that the image data may be configured for display via the display device 101. Thus, the remote data center 105 is any system operable to communicate with the accessory display data module 104. For example, the remote data center 105 may be a remote server hosting software that operates as a clearinghouse for images selectable by a user of the processing device 103 via the display data module 104. Once an image is selected in this image “pull” scenario, the remote data center 105 transfers the image to the display data module 104 which, in turn, configures it for display via the display device 101. Alternatively or additionally, the image may be “pushed” from the remote data center 105 to the display data module 104. For example, a user of the processing device 103 may subscribe to a service which automatically delivers images for display via the display device 101. The remote data center 105 may propagate the images from the subscription to the display data module 104 for display via the display device 101. Other exemplary operations of the remote data center 105 are described below.

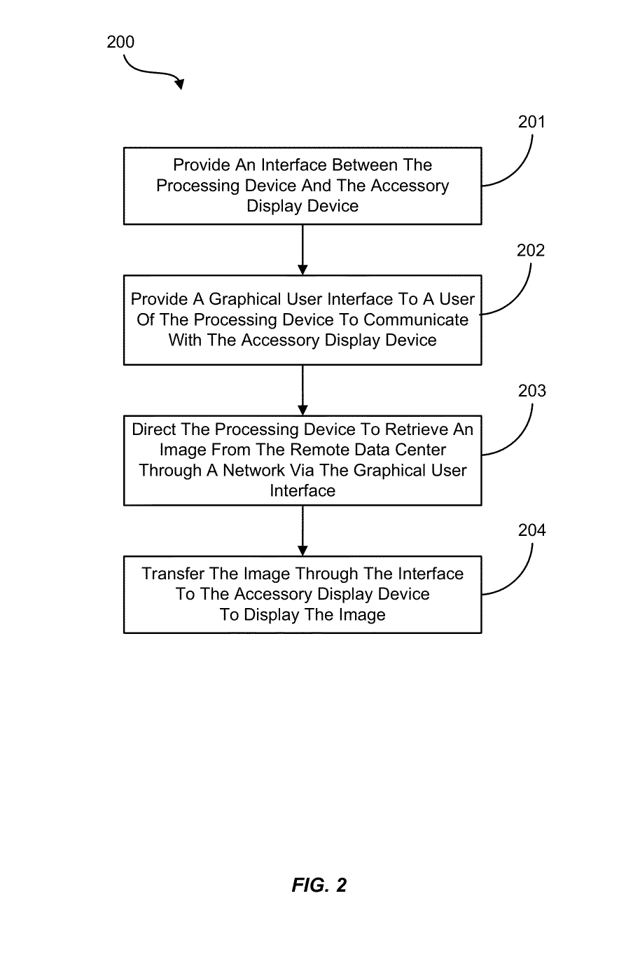

FIG. 2 is a flow chart 200 of an exemplary process of the system of FIG. 1. The method 200 initiates when the display data module 104 of the processing device 103 interfaces with the display device 101 via the interface 102, in the process element 201. For example, the interface 102 of the display device 101 may be physically coupled to the processing device 103 through a communication port of the processing device 103. The display data module 104 may then be operable to communicate image data to the display device 101 via interface 102.

The display data module 104 provides a graphical user interface to the user of the processing device 103 to communicate with the display device 101, in the process element 202. For example, the display data module 104 may include software operable on the processing device 103 to establish a graphical user interface on a display module of the processing device 103 itself, such as the touch screen display of a smart phone or a tablet computer. From the graphical user interface, the user may direct the processing device to retrieve an image from the remote data center 105 through a network (e.g., via push and/or pull functionality) shown and described in greater detail below), in the process element 203. The display data module 104 may in turn transfer the image through the interface 102 to the display device 101 to display the image, in the process element 204.

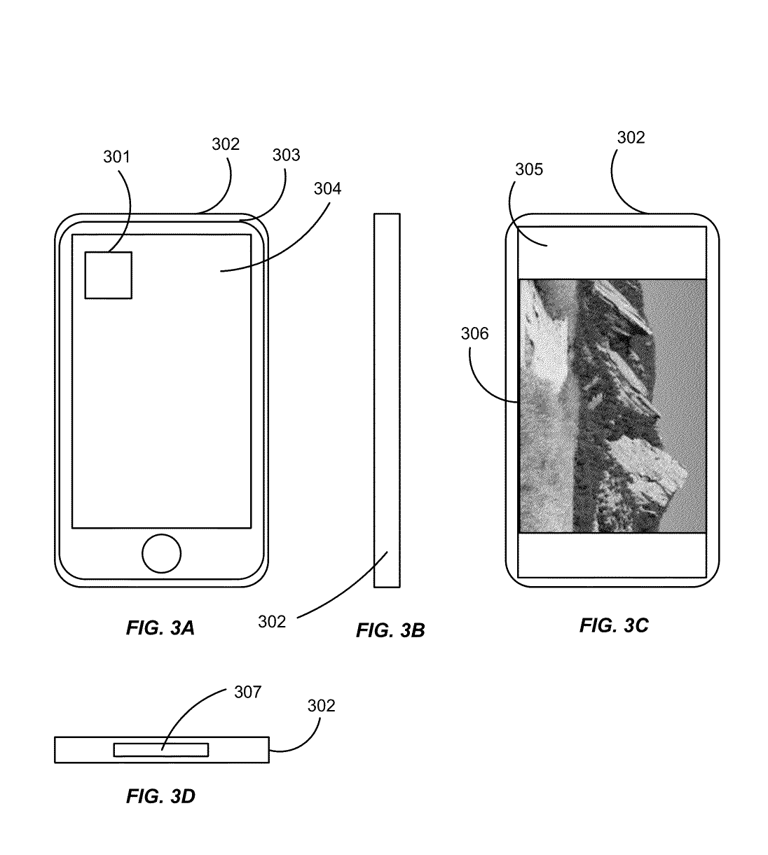

FIGS. 3A-3D are exemplary views of a smart phone 303 implementing the system of FIG. 1. FIG. 3A illustrates the front side of the smart phone 303 having a touch screen interface 304. The display device 101 is configured as a case 302 that interconnects with the smart phone 303 via the communication port 307 of the smart phone 303 (e.g., a serial port, the 30 pin Apple iPhone connector, Ethernet, or other physical link), as shown in FIG. 3D. In other embodiments, however, the display device 101 may be communicatively coupled to the processing device via other technologies (e.g., wireless, Bluetooth, etc.). As mentioned, the display data module 104 may be implemented as a software module. In this regard, the display data module 104 may be a software application or “app” 301 operable in the operating system environment of the smart phone 303. The app 301 may be displayed via the touch screen interface 304 for selection by the user. The app 301 may be used to select an image 306 for display via the display module 305 of the display device 101, as shown in FIG. 3C.

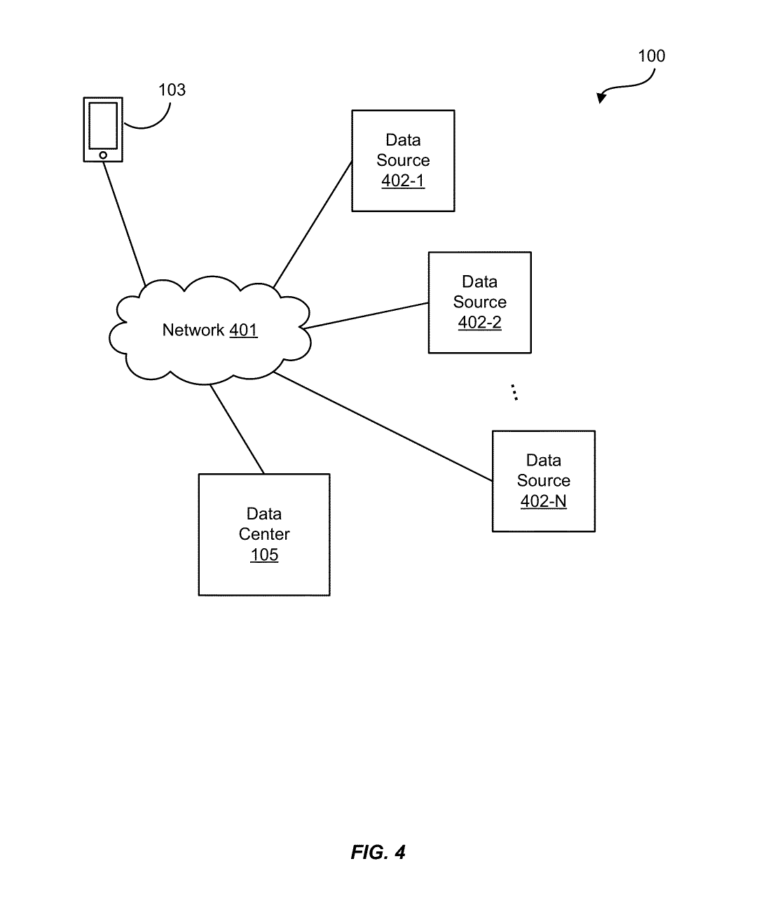

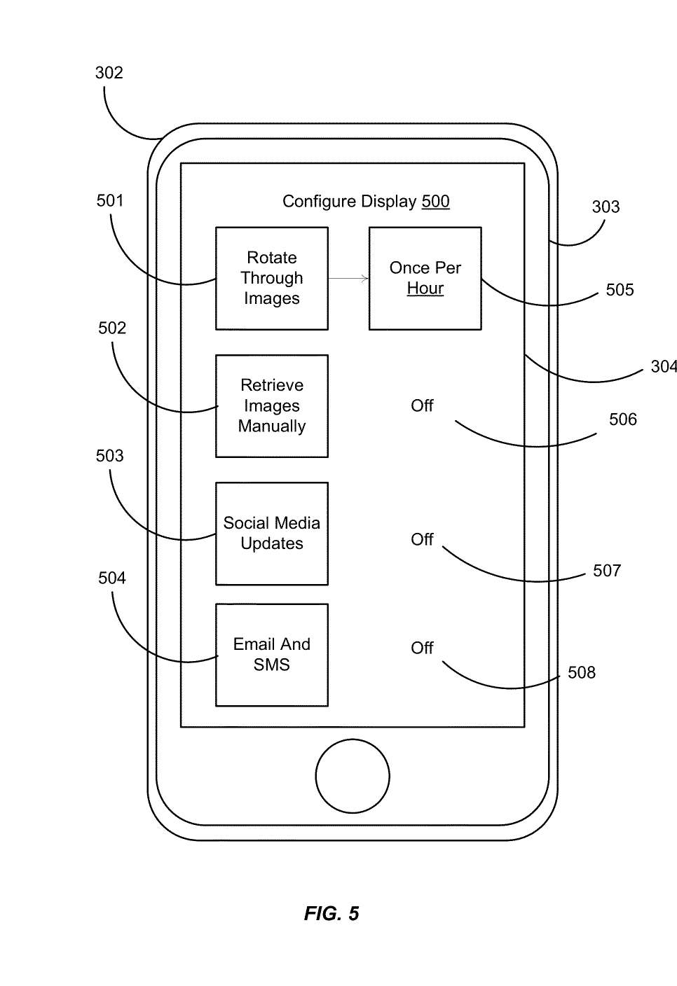

FIG. 4 is block diagram of the system 100 of FIG. 1 interacting with a plurality of data sources 402-1-N (where the reference numeral “N” is merely intended to represent an integer greater than “1” and not necessarily equal to any other “N” reference numeral disclosed herein). In this embodiment, the processing device 103 communicates to the remote data center 105 through a network 401 (e.g., the internet or other data network) via the display data module 104 that is configured with the processing device 103. The display data module 104 requests image data from the remote data center 105 through the network 401. The data sources 402-1-N may store or otherwise maintain image data for the data center 105. The data center 105 operates as a clearinghouse or marketplace for the image data. For example, the data source 402-1 may include image data licensed by the National Football League (NFL) whereas the data source 402-2 may include image data licensed by the National Basketball Association (NBA) and the data source 402-N may include image data of various designers such, as Louis Vuitton, Guess, and Gucci. The data center 105 interfaces with these data sources 402 through the network 401 to provide their various images to the user of the processing device 103 for selection via the display data module 104. A user of the processing device 103 may then select desired images from the data sources 402 through the display data module 104 such that one or more of the images may be displayed on the display device 101 configured with the processing device 103. FIGS. 5-8 further illustrate the image selection and display process that may be provided by the display device 101 and the display data module 104.

In FIG. 5, the smart phone 303 is illustrated with an exemplary graphical user interface 500 on the “front side” of the smart phone 303 which displays the configuration options for the display device 101 when the display data module 104 is selected by the user of the smart phone 303. For example, once the app 301 is selected by the user, the app 301 may call a software module that allows a user to configure the display features of the display device 101 via the touch screen 304 of the smart phone 303. Such features may include rotating through a plurality of images (element 501) for a certain period of time. For example, the display device 101 generally consumes power when an image is initially presented for display via the display device 101. That is, once displayed, the static image consumes little or no battery power of the processing device. As each refresh of the display device 101 consumes battery power, the user may wish to update the image presented to the display device 101 of the case 303, manually, intermittently, or periodically. Accordingly, the user may establish a period of time, such as once per hour as illustrated in element 505, in which images are retrieved and displayed on the display device 101. The display data module 104 may then automatically retrieve images from the data center 105 and/or from local storage on the smart phone 303 at a period of time designated by the user.

In one embodiment, the user may retrieve images manually (element 502) for display via the display device 101. For example, the user may access images from the data center 105 at will and/or retrieve images that are locally stored from the smart phone 303 for display as desired. As exemplarily shown herein, this feature may be turned off when the user selects to automatically rotate through images.

Alternatively or additionally, image data may be configured from or with social media updates (element 503). For example, a social media website such as Facebook generally posts updates to a user based on certain posting configurations that the user may set. To illustrate, suppose a user wishes to receive social media updates from one particular person out of many in their contact list. The user may configure the social media website to only post updates of that person to the user's device. Element 503 provides this and other functionality by allowing the user to configure the social media website's push functionality to the accessory display device 101. Once configured, the social media website may send data to the smart phone 303 for display to the display device 101. Of course, the invention is not intended to be limited to any particular type of transaction between the display data module 104 and a social media website as such configurations may be a matter of design choice and/or user selection. And, this feature may be even turned off if desired (element 507).

Image data may also be configured from or with certain messaging features such as SMS (Short Message Service) messaging, e-mail (element 504), and calendars. For example, data received through the smart phone 303 from text messages may be automatically posted to and displayed with the display device 101 when desired by the user. The configure display module 500 of the display data module 104 may provide this and other functionality and/or even turn the functionality off if desired (element 508). Accordingly, the invention is not intended to be limited to any particular display configuration for the display device 101.

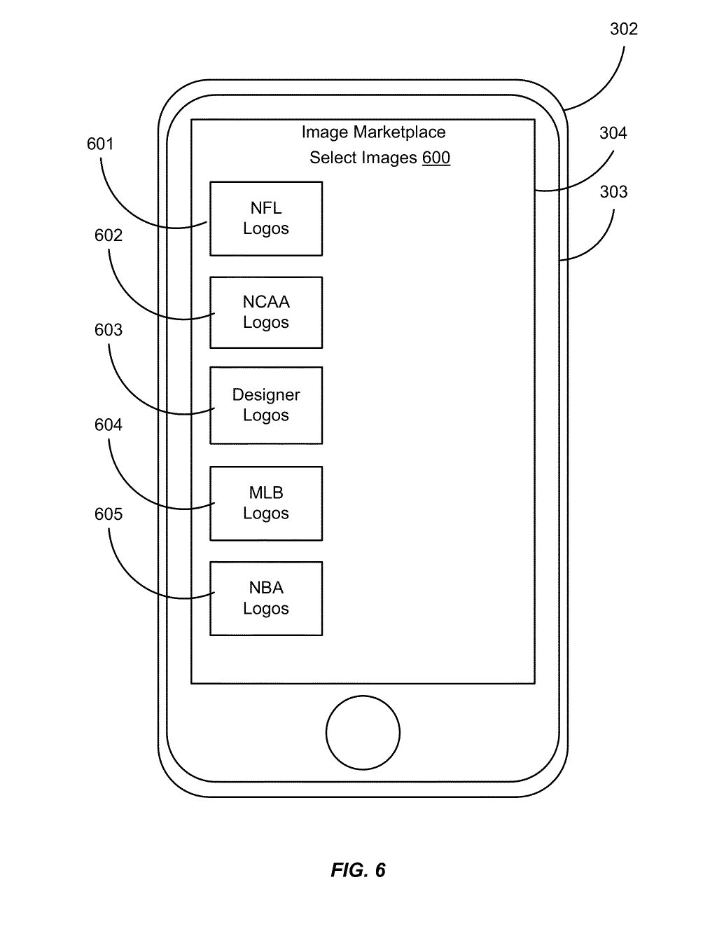

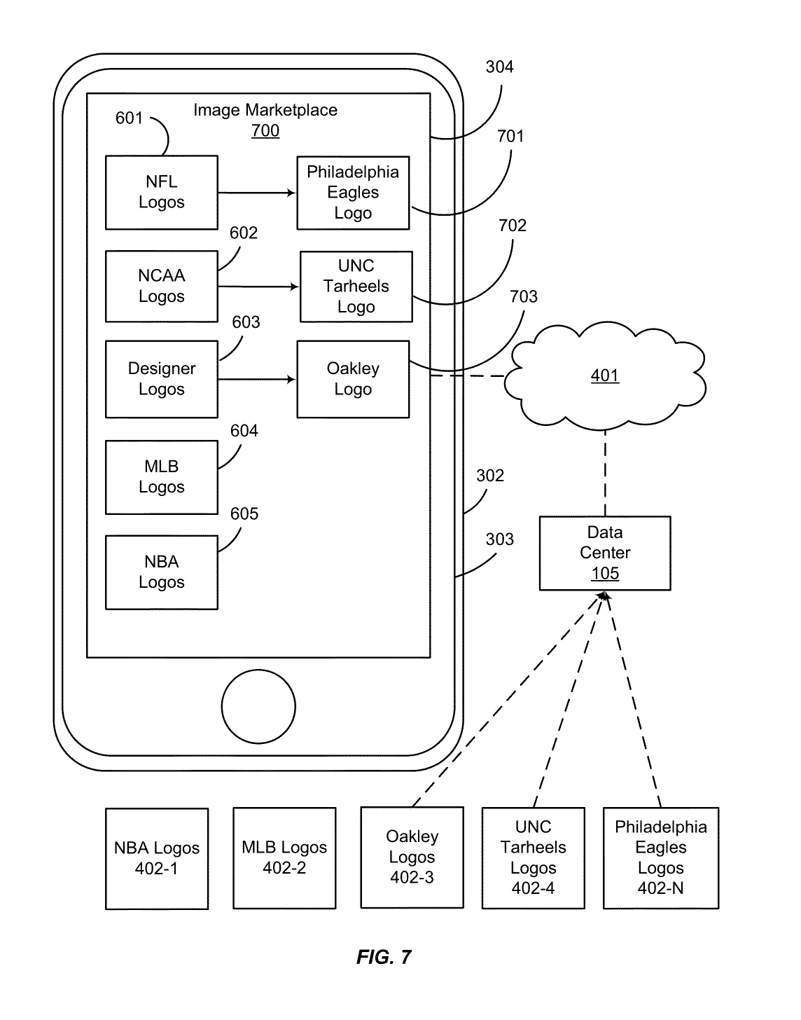

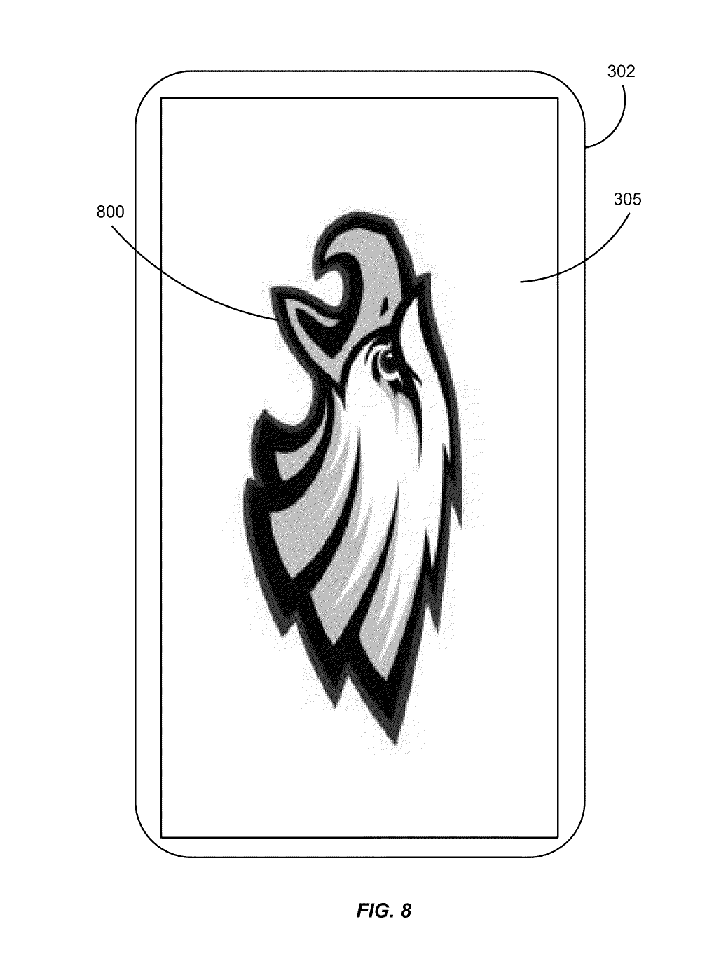

FIG. 6 represents an image marketplace provided by the data center 105. As mentioned above, the data sources 402-1-N may provide a variety of different types of data that may be converted into images for presentation via the display device 101. In this embodiment, the data sources are selected in a Select Image 600 user interface from NFL logos 601, NCAA logos 602, designer logos 603, MLB logos 604, and NBA logos 605. FIG. 7 illustrates certain images that are selected by the user. For example, once the user selects the NFL logos 601, NCAA logos 602, and the designer logos 603, the user may be prompted to select logos from NFL teams such as the Philadelphia Eagles, NCAA teams such as the University North Carolina Tar Heels, and designer logos such as Oakley in the elements 701-703. Once these logos are selected, the display data module 104 may communicate with the data center 105 to retrieve the desired images. The data center 105 then retrieves the images from the appropriate data sources 402 (e.g., data sources 402-3, 402-4, and 402-N). Based on the display configurations previously selected by the user (see e.g., FIG. 5 and the related discussion), the display data module 104 displays the image on the display module 305 of the display device 101 that is configured with the case 302. In this instance, an image of the Philadelphia Eagles logo 800 is selected for display as illustrated in FIG. 8.

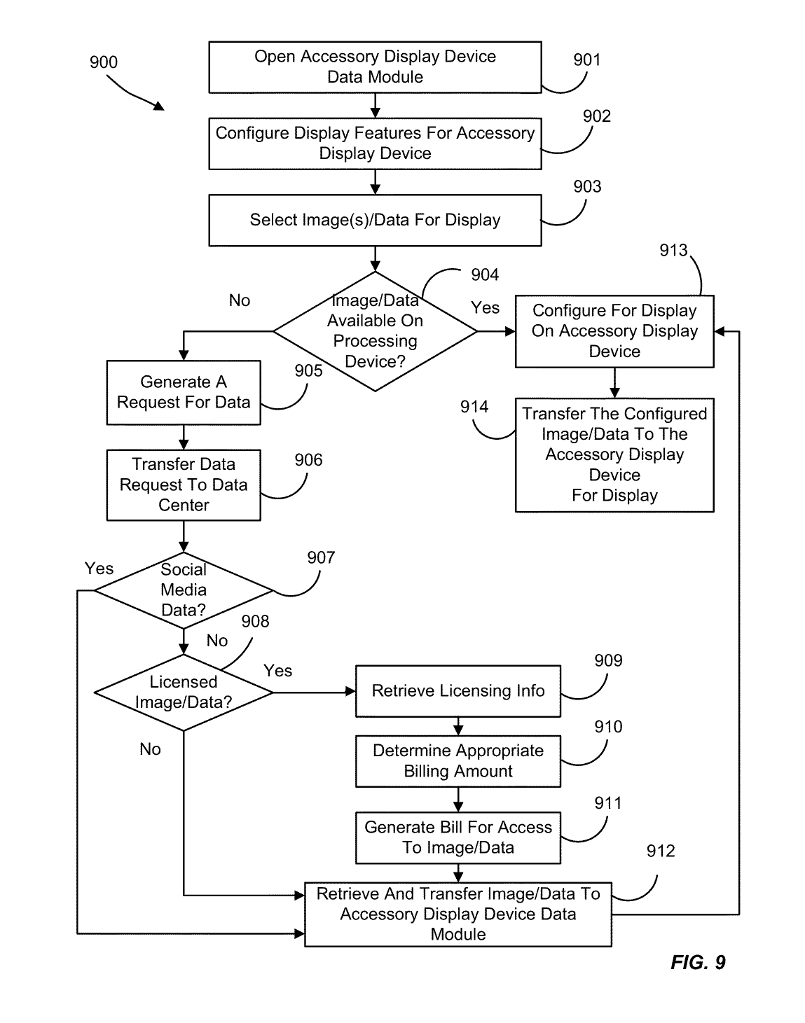

It should be noted that the types of image data provided by the data sources 402 in FIGS. 6-8, are merely exemplary and not intended to limit the invention in any way. For example, NFL logos may not be the only forms of image data provided by an NFL data source 402. And NFL data source 402 may provide images of certain players or stadiums. Accordingly, the forms of image data provided by the data sources 402 is not intended to be limited to any particular type of image data. It should also be noted that the image is not intended to be limited to any particular licensing aspects that may be associated with the images. For example, the remote data center 105 may be operable to store licensing information with respect to each of the available data sources 402. However, as licenses are generally negotiable instruments, each of the licenses may vary among the data sources. For example, one licensing agreement for obtaining NFL images may provide a single fee for access to any images that the NFL data source 402 would provide. A licensing agreement for NBA images, on the other hand, may require payment for each individual image while another data source may require a subscription for certain images. The remote data center 105 may retain the licensing agreements such that the data center 105 may establish electronic transactions between the user of the processing device 103 and the data sources 402 via the display data module 104. An example of such a process is illustrated in FIG. 9.

FIG. 9 is another exemplary flowchart 900 of the system of FIG. 1. In this embodiment, the user of the processing device 103 initiates image display via the display device 101 by opening the display data module 104, in the process on the 901. As mentioned, such may be a software application operable within the operating system environment of the processing device 103. From there, the user may configure the display features for the display device 101, in the process element 902, as similarly described with respect to FIG. 5. Then, the user may select images for display on the display device 101 via the graphical user interface of the display data module 104, in the process element 903. As mentioned, the configuration features of the display device 101 may be performed automatically or manually. Thus, if the display data module 104 is configured to automatically display images, then the user may be relieved of selecting image data for display via the display device 101. In other words, the display data module 104 may be operable to automatically select images on behalf of the user assuming that the user has properly subscribed to receiving such images. The display data module 104 may in turn determine whether the image and/or data is available on the processing device 103, in the process element 904.

If the image/data does not presently exist on the processing device 103, the display data module 104 generates a request for data, in the process element 905, and transfers that request to the data center 105, in the process element 906. Once received, the data center 105 determines whether the data being requested is social media data, in the process element 907. If so, then the data center 105 accesses the social media requested by the display data module 104 as configured by the user. Using the example of Facebook again, posts from certain people on the user's Facebook contact list may be selected for display via the display device 101 when configured in the display data module 104. The remote data center 105 then contacts the particular social media server to retrieve the image and/or data as desired by the user and transfers that image and/or data to the display data module 104 for display via the display device 101, in the process element 912. The display data module 104 then configures the image/data for display via the display device 101, in the process element 913. For example, if the requested image/data consists of simple text, the display data module 104 may configure the text as an image presented in a particular format (e.g., white background, black font, framed, etc.). The display data module 104 then transfers the configured image/data to the display device 101 for display, in the process element 914.

If the requested data is licensed, then the remote data center 105 determines such in the process element 908. If the data is licensed, then the remote data center 105 retrieves the licensing info associated with the image/data requested by the user, in the process element 909. For example, if the user has subscribed to receive certain images from a data source 402, then the data center 105 may determine whether the user's account remains valid (e.g., has sufficient funds, has not violated the terms of the license, etc.). If the user's account is valid, then the data center 105 may determine whether there is any appropriate billing amount for the requested data in the process element 912 (per the terms of the users license). If billing is deemed appropriate, then the remote data center 105 may generate a bill or invoice for access to the requested data, in the process element 911. The user may, if necessary, pay the invoice via the display data module 104 such that the image/data may be retrieved and transferred to the display data module 104, in the process element 912. However, the invention is not intended to be limited to any particular form of payment process. For example, the remote data center 105 may establish a form of online billing which the user may access via a website. Alternatively or additionally, the user may establish an account with the remote data center 105 from which the remote data center 105 deducts appropriate amounts for images. If the requested image/data is not licensed (e.g., there are no intellectual property rights associated with the image/data), then the remote data center 105 simply retrieves the image/data and transfers the image/data to the display data module 104, in the process element 912. The display data module 104 then configures the selected image/data for display via the display device 101, in the process element 913 and transfers the configured image to the display device 101, in the process element 914.

Returning to the process element 904, if the image/data is available on the device, then the display data module 104 configures the selection for display on the display device 105, in the process element 913. Once configured, the display data module 104 transfers the configured image/data to the display device 101 for display, in the process element 914.

In one embodiment, the display data module 104 provides certain editing features that allow the user to make changes to images and/or data being presented to the display device 101 for display. For example, if an image from the user's desired social media website is presented to the display data module 104, then the user may access photo editing software via the display data module 104 to add certain features such as text to the retrieved image.

While some basic examples of data sources 402 have been shown and described above, the invention is not intended to be limited to any particular type of data source. Examples of other data sources 402 include various news articles, sports scores, stock quotes, weather updates, images of artwork, photographs, and the like that may be grouped together in some format or provided alone periodically via push display functionality. For example, the accessory display data module 104 may be operable to configure an image of art as a background with text overlays that includes news articles, sports scores, and stock quotes, etc. Other examples of data sources 402 include Pinterest, Instagram, and Spotify (e.g., images illustrating what the user the processing device 103 is listening to), etc.

In other examples, data sources 402 may be configured within the accessory display data module 104 itself. For example, the processing device 103 may be configured with a storage module that is accessible by the accessory display data module 104 to retrieve various forms of data, such as relationship statuses, gamer statuses, stored images, etc. The accessory display data module 104 may access the storage module of the processing device 103 for optional editing via the display module of the processing device 103 and ultimate display via the accessory display device 101.

In one embodiment, the accessory display data module 104 may be configured with a “Friend Finder”. For example, the accessory display data module 104 may interact with a GPS system of the processing device 103 and detect when a friend is located in the near proximity. In doing so, the display data module 104 may detect the user's location and receive information pertaining to a friend's location from the friend's device and post that information on the display device 101. The accessory display data module 104 may even be configured to form a custom network of friends and direct the accessory display device 101 turn a certain color or display their image when one of the friends in the network is within an established proximity to the user's processing device 103. Alternatively or additionally, the accessory display data module 104 may detect any location of a friend within the network and display that location on the accessory display device 101. The accessory display data module 104 may even be configured to interact with the camera module 1000 of the processing device 103 to take pictures and push those pictures to one or more friends in the custom network such that the pictures may be displayed with the accessory display devices of their processing devices, and vice versa.

Similarly, the accessory display data module 104 may be operable to interact with the GPS system of the processing device 103 to locate various businesses within proximity of the processing device 103 such that the remote data center 105 can push images relevant to those businesses (e.g., coupons, advertisements, etc.) to the accessory display data module 104 for display via the accessory display device 101.

The accessory display data module 104 may, in another example, display a personal QR code on the accessory display device 101. For example, another person with a QR code scanner application on a smart phone may be able to scan the QR code displayed on the accessory display device 101 and be directed to the user's website to the user.

Another embodiment includes triggering the accessory display device 101 to display an image and/or information when we processing device 103 is lost or misplaced. For example, a user of the processing device 103 may access a computer terminal to send an e-mail, text message, or the like, to automatically trigger the accessory display data module 104 to display information showing that the processing device 103 is misplaced by the user. Such information may include contact information of the user so that someone coming across the processing device 103 may return the processing device 103.

Another embodiment may include configuring the accessory display data module 104 to interact with the camera module 1000 of the processing device 103 to photograph your clothing attire such that the accessory display data module 104 may configure an image (e.g., a color) that coordinates with your clothing attire.

Another embodiment includes providing a sort of mobile storefront on the accessory display device 101. For example, the accessory display data module 104 may access the remote data center 105 to retrieve sale items of the user of the processing device 103. In this regard, the user may access a website, such as craigslist or eBay, to display items for sale and then configure the accessory display data module 104 to retrieve those items from the website via the remote data center 105. Then, the accessory display data module 104 may configure those items for display via the accessory display device 101. Alternatively or additionally, the accessory display data module 104 may be configured to periodically retrieve sale information that a user is watching on those websites such that the user of the processing device 103 can observe certain activities relating to those sales.

In yet another embodiment, the display data module 104 may be configured to interface with a communication module of the processing device 103 to retrieve images. For example, the display data module 104 may interface with a Bluetooth module of a smart phone to retrieve an image from another smart phone. Examples of such data retrieval are found in the functionality of the “Bump” application available on many smart phones. Similarly, the display data module 104 may be configured with the display device 101 to communicate with the processing device 103 albeit separate from the processing device 103. For example, if a user were wearing a name tag configured from the display device 101 and the accessory display data module 104 was configured therewith, the display data module 104 may communicate with processing device 103 to retrieve images from the processing device 103 for display with the display device 101. That is, the display data module 104 may be configured with a communication device, such as Bluetooth, that is operable to communicate with the processing device 103 to retrieve images without physical connection to the processing device 103.

In yet another embodiment, the display data module 104 may be used for multidimensional product viewing. For example, the display data module 104 may be operable to display a view of a particular product and transmit an alternate view of that product to the display device 101 such that two views of the same product can be displayed at the same time.

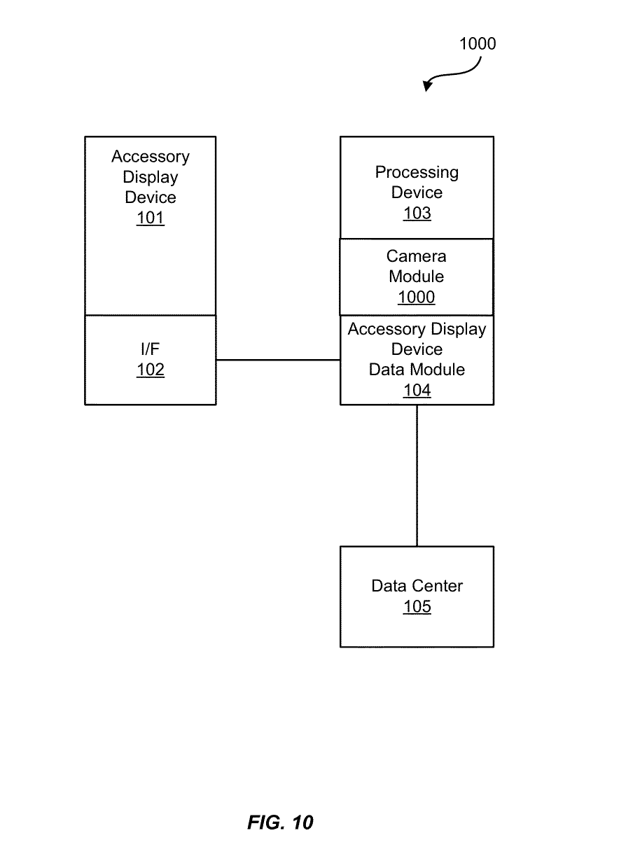

FIG. 10 is another block diagram of the exemplary system of FIG. 1 operable with a camera module. For example, the processing device 103 may be configured with a camera module 1000 to take pictures of images desired by the user. Examples of the camera module 1000 are commonly found in smart phones, tablets, computers, and the like. The display data module 104 may be operable to interface with the camera module 1000 and retrieve the images taken by the camera module 1000 to configure them for display via the display device 101. In one particular embodiment, the display data module 104 is operable to allow the user to take a snapshot of a surface, such as a tabletop, such that the image of the surface may be displayed to the display device 101, thereby providing a sort of camouflage effect for the smart phone when the touch screen interface of the smart phone is laid upon the surface.

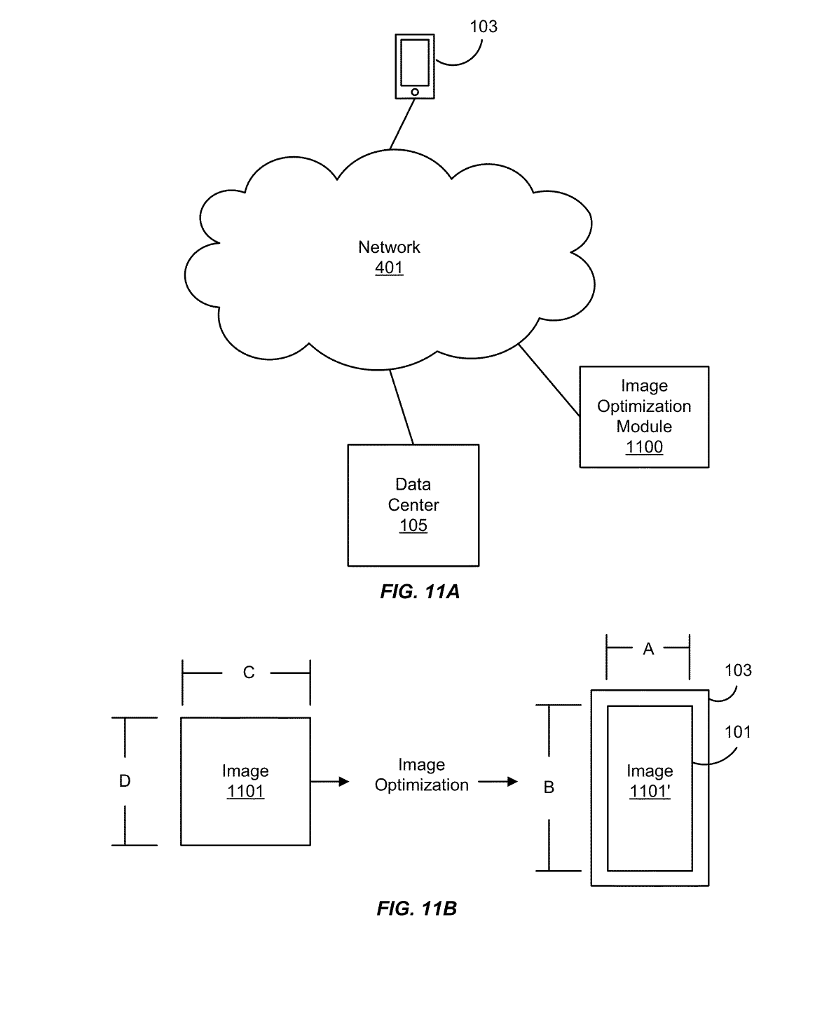

FIGS. 11A and 11B illustrate image optimization for the accessory display device 101. As with previous embodiments, the remote data center 105 may be communicatively coupled to the processing device 103 to provide images to the accessory display data module 104 of the processing device 103 for display via the accessory display device 101 coupled therewith. As the images may come from a variety of data sources 402, the sizes of the images may also vary dramatically. For example, an image from one data source 402 may differ in resolution from an image of another data source 402. More particularly, however, one or more of these images may not be optimized for the resolution of the accessory display device 101. In this embodiment, an image optimization module 1100 is operable to process images that are to be displayed with the accessory display device 101. Thus, the image optimization module 1100 is any system, software, hardware, or combination thereof that is operable to process an image to optimize the resolution of the image to that of the accessory display device 101. The image optimization module 1100 may be operable external to the data center 105, within the data center 105, or even as part of the accessory display data module 104.

To illustrate, the resolution of the accessory display module 101 may have a resolution of A×B pixels. An image 1101 that is destined for display via the accessory display module 101 may have a resolution of C×D pixels. The image optimization module 1100 may use any of a variety of image optimization algorithms to detect the resolution of the image 1101 and convert the C×D resolution image 1101 to the A×B resolution image 1101′, such that the image 1101′ displays properly within the display confines of the accessory display device 101. Some examples of such image optimization may include stretching, shrinking, and/or centering the image 1101.

However, the invention is not intended to be limited to any particular form of optimization. In fact, the image optimization module 1100 may also be operable to process multiple images for display via the accessory display device 101. For example, the image optimization module 1100 may format multiple images by overlaying and/or sizing the images such that they display with the accessory display device 101.

Of course, to properly display the image 1101 within the available display real estate of the accessory display device 101, it is generally advantageous to know the resolution of the accessory display device 101. Accordingly, the accessory display data module 104 may detect the resolution of the accessory display device 101 when interfacing. For example, the accessory display data module 104 may include a driver of the accessory display device 101 that detects when the accessory display device 101 interfaces with the processing device 103 through the interface 102. During this handshaking process, the accessory display data module 104 may detect the resolution of the accessory display device 101 and report the resolution to the data center 105 such that the image optimization module 1100 may configure images according to the resolution of the display device 101. As mentioned, the image optimization module 1100 may also be configured with the display data module 104 such that images stored with the processing device 103, for example, may also be optimized for display via the display device 101.

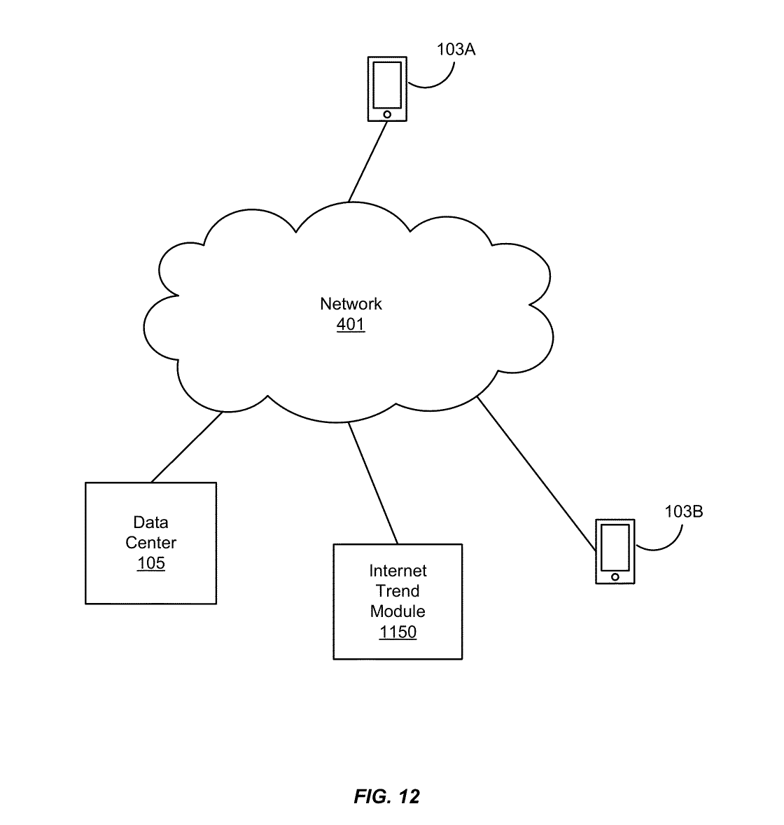

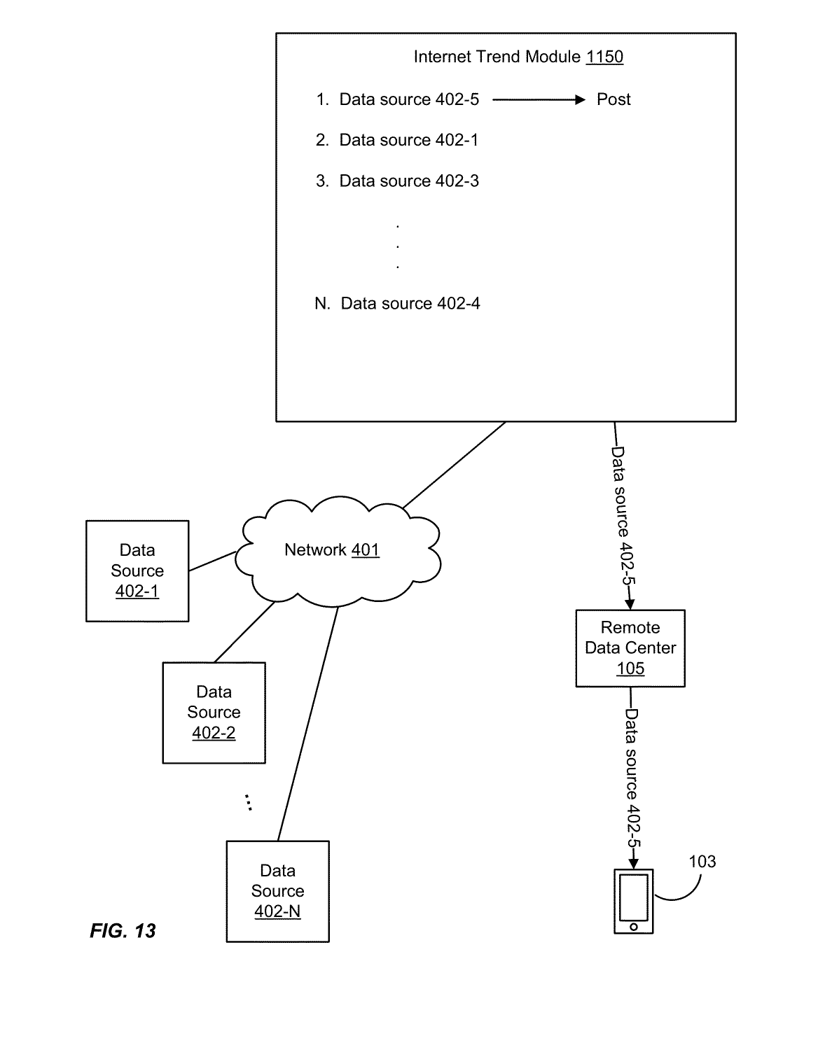

FIGS. 12 and 13 are block diagrams illustrating Internet trending functionality that may be implemented with the system of FIG. 1. In FIG. 12, an internet trend module 1150 is configured with the functionality described above to provide images that may be popular or “trending” at the moment. For example, many internet websites, such as Yahoo and OneRiot, provide statistics on the most viewed content on the Internet at the moment to entice viewers to switch to that content, because marketers may be interested in that type of data. In other words, if a majority of users are accessing data relating a particular topic, such as a celebrity's “tweets” on Twitter, then more people may be inclined to switch to that content. And, if more people switch to that content, then more people may also view marketing content therewith, comparable to people viewing commercials during popular television shows.

Because of the rather quick statistics of the trending websites, people are quickly driven to these websites. In this regard, people may desire the quickest access to the trending information. But, because people are often busy and away from the Internet, mobile devices are often the quickest and easiest way to access the trending information. To provide this trending information, the remote data center 105 may access trending data from the Internet trend module 1150 for configuration with and transmission to the processing device 103A. For example, if information regarding a particular celebrity is trending and the user of the processing device 103A is interested in that celebrity, the user may direct the data center 105 to push certain information regarding that celebrity to the processing device 103A. The data center 105 may then access the trending information regarding that celebrity from the Internet trend module 1150 and configure it for display via the accessory display device 101 configured with the processing device 103A. Of course, the information trending on the Internet provided by the Internet trend module 1150 may be virtually anything.

In another embodiment, the Internet trend module 1150 is operable to detect what is displayed on another user's processing device. For example, suppose a celebrity is the user of the processing device 103B. The Internet trend module 1150 may be operable to detect or otherwise know of an image being displayed on the accessory display device 101 configured with the processing device 103B. And, as people may be interested in also displaying an image that a particular celebrity is displaying with the processing device 103B, the Internet trend module 1150 may inform the remote data center 105 of the image being displayed on the processing device 103B such that the remote data center 105 may push the image to the processing device 103A for the user of that display may display the same image of a celebrity using the processing device 103B. As a further illustration, suppose the recording artist Jay-Z (Shawn Corey Carter) has an accessory display device 101 configured with his smart phone. And, on that accessory display device 101 is an image relating to the clothing line of “Rocawear”, founded by Jay-Z. People interested in Jay-Z and his clothing line may wish to display that image on the accessory display device 101 configured with their processing device 103A. The data center 105, once configured by the user of the processing device 103A, may push that image to the user's processing device 103A so that it may be automatically displayed with the accessory display device 101.

In another embodiment, the data center 105 may be operable to interact with the Internet trend module 1150 to push images/data to the celebrity's processing device 103B. For example, the Internet trend module 1150 may detect that a particular celebrity is trending on the Internet. The data center 105 may access this trending information to push some form of advertising image to the processing device 103B of that celebrity as a means of marketing. Thus, when that celebrity is in public, the image displayed with the accessory display device 101 of the celebrity's processing device 103B may be visible. Additionally, those interested in what that celebrity is displaying on the accessory display device 101, may also access that image/data from the remote data center 105 (i.e., in either a push or pull format) as it may also be of interest to them.

Although shown and described with respect to the Internet trend module 1150 being configured external to the remote data center 105, the invention is not intended to be so limited. In some embodiments, the Internet trend module 1150 may be operable as a component of the remote data center 105. In other embodiments, portions of the Internet trend module 1150 may also be configured with the processing device 103. For example, the accessory display data module 104 may comprise a component of the Internet trend module 1150 so that a user may quickly access trending information via the processing device 103. The remote data center 105 may then interact with the accessory display data module 104 to retrieve images/data associated with the trending information accessed by the user of the processing device 103.

FIG. 13 further illustrates the operation of the Internet trend module 1150. In this embodiment, Internet trend module 1150 monitors the network 401 to determine which data sources 402 are trending. The Internet trend module 1150 then ranks those data sources. As shown in this example, Internet trend module 1150 ranks the data sources 402 in the following order: 1. 402-5; 2. 402-1; 3. 402-3; . . . ; N. 402-4. The user of the processing device 103 may direct the remote data center 105 to retrieve only the number one trending items on the network 401 each hour. Accordingly, the remote data center 105 retrieves the information and/or image data pertaining to the data source 402-5 and configures it as an image for display via the accessory display device 101 configured with the processing device 103.

Internet trend module 1150 may also be operable to determine a user is trending potential. For example, the Internet trend module 1150 may ascertain information pertaining to the user's social media accounts to determine a score for the user's ability to interact with others on the Internet. If the user maintains a relatively high score, the Internet trend module 1150 may report this information to one or more of the data sources 402-1-N such that the data sources may automatically push images/data to the user's device 103. To illustrate, a celebrity may have a relatively high social media score. Accordingly, marketers may wish to display images relating to their goods and services on the celebrity's processing device as similarly described above. Thus, based on the celebrity's score, a data source 402 may be inclined to market on that celebrity's processing device.

Of course, the invention is not intended be limited to any particular entity. For example, a score may be determined based on a smaller network of individuals and, as such, may be subject to marketing on a smaller scale. To illustrate, one person in a neighborhood may have considerable influence over others in the neighborhood. The Internet trend module 1150 may recognize this influence based on the social media interaction of that person. The Internet trend module 1150 may transfer this information to one or more of the data sources 402-1-N that are more local to the neighborhood, such as grocery stores, restaurants, etc. Thus, a data source 402 may be inclined to send marketing and/or coupons to that user to influence other neighbors to visit the businesses thereof.

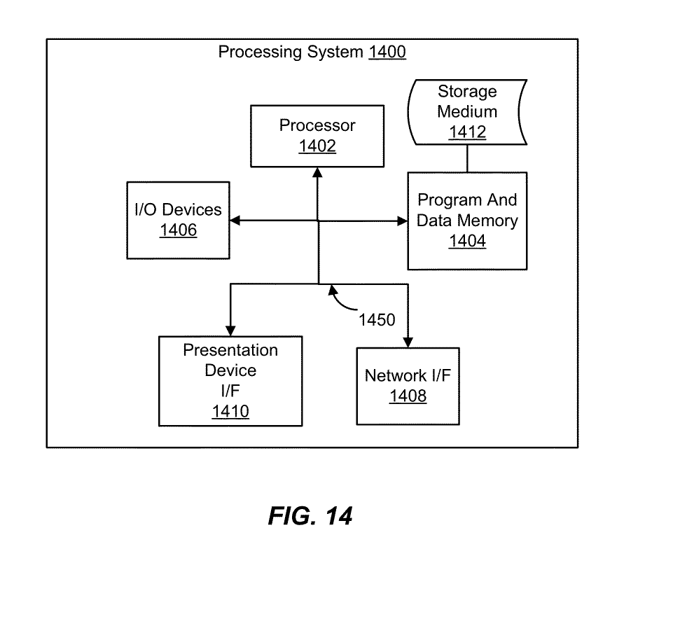

FIG. 14 is a block diagram depicting a processing system 1400 also operable to provide the above features by executing programmed instructions and accessing data stored on a computer readable storage medium 1412. In this regard, embodiments of the invention can take the form of a computer program accessible via the computer-readable medium 1412 providing program code for use by a computer or any other instruction execution system. For the purposes of this description, computer readable storage medium 1412 can be anything that can contain, store, communicate, or transport the program for use by a computer.

The computer readable storage medium 1412 can be an electronic, magnetic, optical, electromagnetic, infrared, or semiconductor device. Examples of computer readable storage medium 1412 include a solid state memory, a magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

The processing system 1400, being suitable for storing and/or executing the program code, includes at least one processor 1402 coupled to memory elements 1404 through a system bus 1450. Memory elements 1404 can include local memory employed during actual execution of the program code, bulk storage, and cache memories that provide temporary storage of at least some program code and/or data in order to reduce the number of times the code and/or data are retrieved from bulk storage during execution.

Input/output (I/O) devices 1406 (including but not limited to keyboards, displays, pointing devices, etc) can be coupled to the processing system 1400 either directly or through intervening I/O controllers. Network adapter interfaces 1408 may also be coupled to the system to enable the processing system 1400 to become coupled to other processing systems or storage devices through intervening private or public networks. Modems, cable modems, IBM Channel attachments, SCSI, Fibre Channel, and Ethernet cards are just a few of the currently available types of network or host interface adapters. Presentation device interface 1410 may be coupled to the system to interface to one or more presentation devices, such as printing systems and displays for presentation of presentation data generated by the processor 1402.

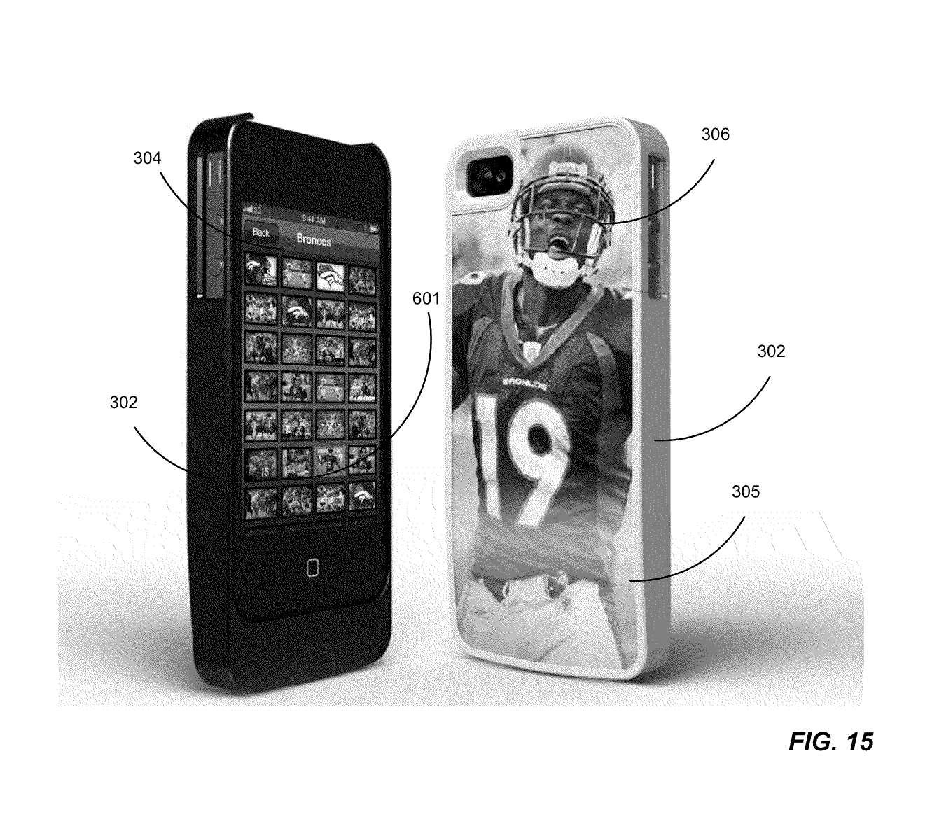

FIG. 15 is a perspective view of a case employing the system of FIG. 1 in an actual reduction to practice. In this embodiment, the case 302 is configured with the display module 305 displaying an image 306 selected from the touch screen interface 304 of an Apple iPhone. As can be seen in this embodiment, the image 306 is selected from a Denver Broncos NFL image selection 601 after initiating the app 301 associated with the display data module 104. Once selected in the app 301, the image 306 is transferred to the display data module 104 for static display via the display module 305 of the display device 101.

While the invention has been illustrated and described in detail in the drawings and foregoing description, such illustration and description is to be considered as exemplary and not restrictive in character. Certain embodiments described hereinabove may be combinable with other described embodiments and/or arranged in other ways. Accordingly, it should be understood that only the preferred embodiment and variants thereof have been shown and described and that all changes and modifications that come within the spirit of the invention are desired to be protected.

1-27. (canceled)

28. A system, comprising:
a remote data server operable to interface with a plurality of image sources, and to retain account information for a plurality of users,
a display data module configured as a software application operable on a smart phone and accessible through a touch screen interface of the smart phone; and
a display device communicatively coupled to the smart phone via a communication port of the smart phone;
wherein the display data module is operable to receive input from a first of the users through the touch screen interface of the smart phone, and to contact the remote data server based on the first user's input,
wherein the remote data server is further operable to process the first user's input,
wherein, based on the first user's input, the remote data server is further operable to retrieve the account information of the first user, to determine an image requested by the first user, to determine whether the first user has a license to the image based on the account information, to contact a first of the image sources to retrieve the image in response to determining that the first user has a license to the image, and to transfer the image to the display data module, and
wherein display data module is further operable to transfer the image to the display device, and to direct the display device to present the image.

29. The system of claim 1, wherein:
the display data module further operable to receive other input from the first user, to retrieve another image from local storage of the smart phone, to transfer the other image to the display device, and to direct the display device to present the other image.

30. The system of claim 1, wherein:
the display data module is further operable to access a global positioning system (GPS) module of the smart phone, and to transfer location information from the GPS module to the remote data server,
the remote data server is further operable to process the location information, to access a social media account of the first user, and to identify a friend of the first user who is proximate to the first user based on the location information, and
the display data module is further operable to transfer location information of the friend to the display device to alert the first user of a location of the friend.

31. The system of claim 1, wherein:
the display data module is further operable to access a global positioning system (GPS) module of the smart phone, and to transfer location information from the GPS module to the remote data server,
the remote data server is further operable to process the location information, and
based on the location information the remote data server is further operable to retrieve an advertisement from the first image source, and to transfer the advertisement to the display data module for presentation via the display device.
